(19) United States
(12) Patent Application Publication
(10) Pub. No.: US 2022/0395802 A1
(43) Pub. Date: Dec. 15, 2022

(54) Flow Reactor and Desulpurization Process

(71) Applicant: EME International Lux S.A., (US)

(72) Inventors: Enrico Carlo Fumagalli, Paradiso (CH); Mark Darius Juszczak, Maspeth, NY (US)

(21) Appl. No.: 17/346,925

(22) Filed: Jun. 14, 2021

(51) Int. Cl. B01J 19/20; B01J 19/10; B01J 19/00; B01J 19/18; C10G 21/20

(52) U.S. Cl. CPC B01J 19/20; B01J 19/10; B01J 19/0013; B01J 19/1862; C10G 21/20; B01J 2219/0871; B01J 2219/0877; C10G 2300/202

(57) ABSTRACT

A flow reactor comprising: a cylindrical body defining a conduit extending from a first end to a second end; a conduit inlet for providing a flow of a liquid reagent into the conduit, the conduit inlet at or near the first end; a conduit outlet for providing a flow of a liquid content from the conduit, the conduit outlet at or near the second end; a rotating screw arranged within the conduit and extending in the conduit, the rotating screw arranged to rotate about an axis extending from the first end to the second end, to direct the liquid content from the conduit inlet to the conduit outlet; and one or more ultrasonic emitters arranged to emit ultrasound waves in the conduit. The flow reactor may be used for desulphurization of fuel oil.

The present disclosure relates to a flow reactor, a system including a flow reactor and a method of activating a reaction in a continuous flow system. The present disclosure also relates to a process for desulphurization of a hydrocarbon fuel, such as a refined crude oil fraction, in particular from heavy fuel oils, such as those used in marine transportation.

Specifications that govern fuels have over the years become increasingly stringent with respect to sulphur content. For environmental protection purposes, many countries have mandated a reduction of sulphur level in diesel and gasoline fuel down to 10 ppm. Commercially, catalytic methods such as hydrodesulfurization (HDS) and some chemical processes for sulphur compounds reductions are the most commonly applied techniques. Similar regulations also apply to other impurities such as nitrogen and the like.

Many industrial chemical processes, including desulphurisation and other impurity removal processes, require long reaction times due to low reaction rates. Chemical reactions performed in this way are often carried out on a batch basis. Reagents are provided into a tank and mixed, the reaction is carried out, and then the products extracted from the tank. This is a slow process and can limit the rate of production of the products.

Energy provided from ultrasound can provide an extremely fine emulsion of liquids and/or assist mass transfer and surface activation in a solid-liquid system. Cavitation from ultrasound creates micro-bubbles. As they reach critical size, the bubbles collapse forming shockwaves and producing very high temperatures, thus increasing the speed of the reaction. However, the process is still a batch process, and this still limits the rate of production of the products.

According to a first aspect, there is provided a flow reactor comprising: a cylindrical body defining a conduit extending from a first end to a second end; a conduit inlet for providing a flow of a liquid reagent into the conduit, the conduit inlet at or near the first end; a conduit outlet for providing a flow of a liquid content from the conduit, the conduit outlet at or near the second end; one or more rotating screws arranged within the conduit and extending in the conduit, the rotating screw arranged to rotate about an axis extending from the first end to the second end, to direct the liquid content from the conduit inlet to the conduit outlet; and one or more ultrasonic emitters arranged to emit ultrasound waves in the conduit.

The flow reactor may comprise one or more further inlets for providing a flow of a further liquid reagent into the conduit, the one or more further inlets arranged along the conduit between the conduit inlet and the conduit outlet.

Each of the one or more screws may comprise a central mounting shaft extending along the axis of rotation with a helical ridge arranged on an outside of the shaft. A direction and/or pitch of the helical ridge may vary along the shaft.

The helical ridge may extend in a first direction in the region of the further inlets, and in an opposite direction between the further inlets. The pitch of the ridge may be longer in the region of the conduit inlet than in regions downstream of the conduit inlet. The pitch of the ridge may be longer in the region of the conduit outlet than in regions upstream of the conduit outlet.

The flow reactor may comprise a pair of screws having intermeshing threads. In other words, in one embodiment, the flow reactor may have two screws and no more.

The flow reactor may comprise one or more cooling channels arranged to direct a cooling gas into the conduit. The cooling channels may be arranged along the conduit between the conduit inlet and the conduit outlet.

The conduit may extend horizontally, and the cooling channels may open into a lower part of the conduit.

The cooling channel my comprise a membrane to block reagents entering the channel.

The flow reactor may comprise heaters arranged to heat the conduit.

The conduit may extend horizontally, and the heaters may be arranged to heat an upper part of the channel.

The flow reactor may comprise a controller arranged to control the heating and cooling to achieve a set temperature in the flow reactor.

The flow reactor may comprise a degassing outlet, arranged to allow escape of gaseous reactant products from the conduit. The degassing outlet may be arranged at or near the second end of the conduit.

The one or more ultrasonic emitters may be arranged at or near of the first end of the conduit.

The conduit may comprise a radially extending opening into the conduit, arranged to receive the ultrasonic emitter.

The first axis may extend horizontally in use.

The inlet may be provided part way along the rotating screw.

According to a second aspect, there is provided a system comprising a flow reactor according to the first aspect; a feed supply for providing liquid reagent to the input of the flow reactor; and a tank for storing product from the flow reactor.

The system may comprise a separator arranged to receive the flow from the conduit outlet of the flow reactor, and arranged to separate the constituent parts of the liquid provided from the conduit outlet.

The system may comprise a catalytic reactor downstream of the flow reactor.

According to a third aspect, there is provided a method of activating a reaction in a continuous flow system comprising: directing liquid reagents through a conduit forming a flow reactor; and agitating the contents of the flow reactor using one or more rotating screws extending along the conduit and ultrasound waves, wherein the agitation caused by the rotating screw and ultrasound is arranged to cause cavitation in the liquid content within the flow reactor, causing the components of the liquid content to chemically react.

The method may comprise directing further liquid reagents into the conduit along the length of the conduit.

The liquid reagents provided at the conduit inlet may include a fuel oil mixture, wherein the further liquid reagents may comprise a mixture of an ionic liquid and water. The reaction may be a desulphurisation reaction.

According to a fourth aspect there is provided a process to desulphurize a hydrocarbon fuel that comprises sulphur compounds, the process comprising: providing a composition comprising the hydrocarbon fuel and source of a reactive species, wherein ultrasound waves are propagated through the composition to activate a reaction between the reactive species and sulphur atoms, to remove sulphur from the hydrocarbon fuel.

The process desulphurizes the hydrocarbon fuel, i.e. at least a portion of the sulphur compounds present in the fuel are removed. The inventors submit that applying ultrasound to the composition improves the desulphurization process.

Without being bound by theory, it is suggested that acoustic cavitation results from propagating an ultrasound wave through the composition. Acoustic cavitation is the formation, growth and violent collapse of microscopic bubbles. The microscopic bubbles are filled with water vapour and dissolved gases. As a result, reactive oxidative species are created from H₂O and O₂ dissociation and their associated reactions in the bubbles.

The ultrasound waves can be generated by means of a transducer (to convert electrical energy signals into ultrasound), i.e. an ultrasonic generator. The transducer may generate a sound wave of a specific frequency. An ultrasonic emitter (e.g. ultrasonic horn) may be coupled to an ultrasonic generator. Any suitable ultrasonic generator and emitter may be used, such as a multi-horn system.

The ultrasound waves may be described with reference to their frequency, which is measured in hertz (Hz) or kilohertz (1 kHz=1000 Hz). The ultrasound waves may have a frequency of at least 50 kHz, at least 150 kHz or at least 300 kHz and/or the sound wave may have a frequency of 1000 kHz or less, 700 kHz or less or 500 kHz or less. The sound wave that propagates through the composition may have a frequency of from 300 to 400 kHz.

The hydrocarbon fuel contains sulphur, which may be in the form of sulphur containing compounds, such as mercaptanes, thiols, thiophenes, and sulphides. Thiophene derivatives include benzothiophene, dibenzothiophene, 4,6-dimethyldibenzothiophene, tetrahydrodibenzothiophene, tetrahydrobenzonaphthothiophene, and octahydrodinaphthothiophene.

The hydrocarbon fuel is liquid during the desulphurization process, and could be described as a liquid hydrocarbon fuel. The hydrocarbon fuel may comprise unprocessed crude oil or a refined crude oil fraction. The hydrocarbon fuel typically comprises a refined crude oil fraction.

The hydrocarbon fuel may constitute (by volume) at least 60%, at least 70%, at least 80%, at least 85%, at least 90% or at least 95% of the composition and/or the hydrocarbon fuel may constitute (by volume) 97% or less, 95% or less, 90% or less, 85% or less or 80% or less of the composition.

The source of a reactive species may comprise an ionic liquid in a water emulsion.

The composition may comprise the hydrocarbon fuel (containing sulphur); an ionic liquid; and water. The composition may be an emulsion, such as a water-in-oil (W/O) emulsion.

The ionic liquid may constitute (by volume) at least 0.1%, at least 0.3%, at least 0.5%, at least 0.8%, at least 1%, at least 3%, at least 5%, at least 7%, or at least 10% of the composition and/or the ionic liquid may constitute (by volume) 20% or less, 15% or less, 10% or less, 5% or less or 3% or less of the composition.

The water may constitute (by volume) at least 1%, at least 3%, at least 5%, at least 7%, or at least 10% of the composition and/or the water may constitute (by volume) 20% or less, 15% or less, 10% or less, 5% or less or 3% or less, or 1% or less of the composition.

Once a selected quantity of hydrocarbon fuel, ionic liquid and water are blended, and optionally emulsified, to form the composition, it is passed through a catalytic reactor. The catalytic reactor may be arranged inline between a mixing tank and a settling tank. The catalytic process binds heavy metals including all sulphur to the ionic liquids. Due to difference in gravity, the emulsion can be left to settle in a separate tank. When settled, the processed oil can be transferred to a service tank or separate clean storage tank for use when needed. The settled ionic liquids containing heavy metals and sulphur can be transferred to a separate flashing unit. The flashing separates the ionic liquids from the heavy metals and sulphur, which is left as a sludge residue within the flashing unit. The ionic liquids are capable of being reused multiple times. The sludge residue is transferred to holding tanks or to separate drying and bagging unit for further handling. The process of the fourth aspect may comprise an additional step of preparing the composition, which may be an emulsion, such as a water-in-oil emulsion.

The composition may be prepared by mixing the hydrocarbon fuel, the ionic liquid(s), and the water. Mixing may take place in a mixing tank before the composition is fed to the catalytic reactor. The flow reactor of the first aspect may serve as a mixing tank for the desulphurization process.

Typically, the ionic liquid and the water are combined to form a pre-mix, and the pre-mix is combined with the hydrocarbon fuel to form the composition as an emulsion. The emulsion may be formed in situ within a flow reactor.

The pre-mix and the hydrocarbon fuel may be combined in the flow reactor of the first aspect. The preparation of the pre-mix is believed to provide benefits compared to simultaneously combining the hydrocarbon fuel, water and ionic liquid. Without being bound by theory, the inventors submit that the use of a pre-mix allows sulphones and sulphoxides to be removed.

The pre-mix may be described with reference to the ratio of the ionic liquid to the water. The ratio by volume of the ionic liquid to the water may be from 1 to 50% ionic liquid to 50 to 99% water, from 5 to 40% ionic liquid to 60 to 95% water, from 10 to 30% ionic liquid to 70 to 90% liquid or 15 to 25% ionic liquid to 75 to 85% water.

Typically, the hydrocarbon fuel is present in the mixing tank and then a pre-mix of the ionic liquid and the water is added thereto.

The composition may be prepared immediately prior to being fed into the catalytic reactor.

In the context of the present invention, the term “ionic liquids” refers to liquids composed entirely of ions that are fluid around or below 100° C.

Ionic liquids (IL), also called liquid electrolytes, ionic melts, ionic fluids, fused salts, liquid salts or ionic glasses are a new class of outstanding good solvents miscible with water or organic solvents, they can be liquid at temperatures of −96° C. and some are liquid at over 400° C. Ionic liquids' low volatility makes them desirable substitutes for volatile organic compounds (VOCs). ILs consist of organic cations, such as ammonium, choline, imidazolium, phosphonium, pyrazolium, pyridinium, pyrrolidinium, quinolinium and sulfonium, and a wide range of anions such as halides, tetrafluoroborate, hexafluorophosphate, bistriflimide, triflate and tosylate.

The ionic liquid may comprise one or more compounds (such as two or more compounds) having:
an imidazolium cation substituted by one or more straight or branched C₁-C₆ alkyl group; and
an anion selected from the group consisting of R₅COO⁻, Cl⁻, Br⁻, [BF₄]⁻, [PF₆]⁻, [SbF₆]⁻, [R₆SO₄]⁻, [OTs]⁻, [OTf]⁻, [OMs]⁻, wherein R₅ is C₁-C₆ alkyl, C₃-C₈ cycloalkyl, benzyl, C₂-C₆ alkenyl, and R6 is C₁-C₆ alkyl.

The imidazolium cation may be substituted in position 1 and 3 by a straight or branched C₁-C₆ alkyl group; and is optionally substituted in position 1 by butyl and in position 3 by methyl.

The anion may be selected from [BF₄]⁻, [OTf]⁻, Cl⁻, and [PF₆]⁻. [OTf]⁻ is trifluoromethanesulfonate, a.k.a triflate. The ionic liquid may comprise 1-butyl-3-methyl imidazolium hexafluoro phosphate and 1-butyl-3-methyl imidazolium tetrafluoroborate.

The ionic liquid may comprise 1-butyl-3-methyl imidazolium hexafluoro phosphate [BMIM-PF₆]; 1-butyl-3-methyl imidazolium tetrafluoroborate [BMIM-BF4]; and/or 1-butyl-3-methyl imidazolium triflate [BMIM-OTf].

The ionic liquid may comprise from 40 to 70% by volume of [BMIM-PF6]; from 25 to 35% by volume of [BMIM-BF₄]; and/or from 10 to 20% by volume of triflate [BMIM-OTf] with respect to the total volume of the ionic liquid.

The process of the fourth aspect may additionally require separating the hydrocarbon fuel and the ionic liquid to yield a desulphurized hydrocarbon fuel.

Separating the hydrocarbon fuel and the ionic liquid may comprise feeding the composition from the catalytic reactor into a settling tank and storing the composition in said settling tank for a settling time (t). This allows the sulphur compounds bonded to the ionic liquid to separate by gravity from the desulphurized hydrocarbon fuel.

The desulphurized hydrocarbon fuel may be transferred to a storage or service tank; wherein, optionally, the settled ionic liquid composition containing the sulphur compounds is then transferred to a flashing unit.

The source of a reactive species may comprise water without an ionic liquid. The water may form an emulsion with the hydrocarbon fuel.

It will be appreciated that features discussed above in relation to a particular aspect may applied to any other aspect, unless mutually exclusive. It will be appreciated that the flow reactor may be used for any continuous chemical process, and that desulphurization is only one example such a process. Likewise, the desulphurization process may take place in any suitable vessel, and the flow reactor is just one example.

Embodiments will now be described, by way of example only, with reference to the following drawings in which:

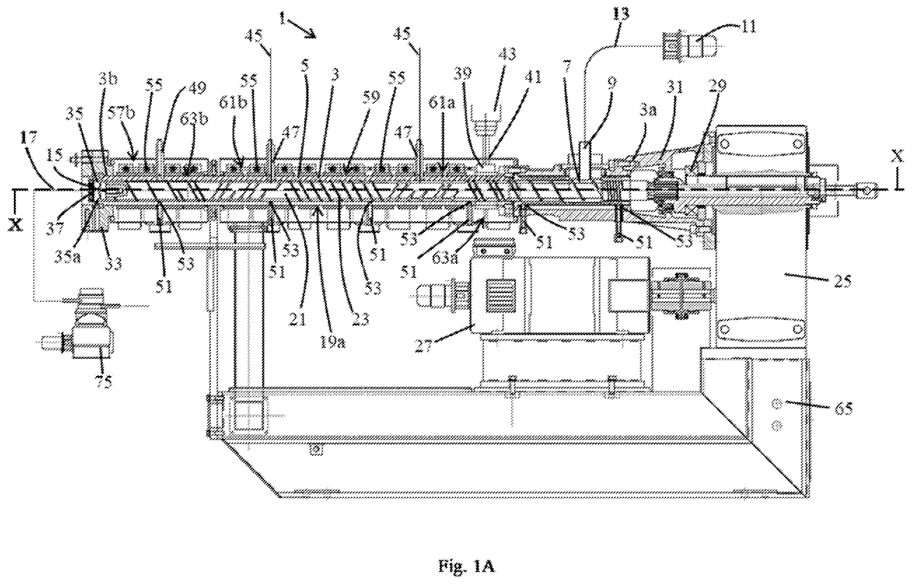

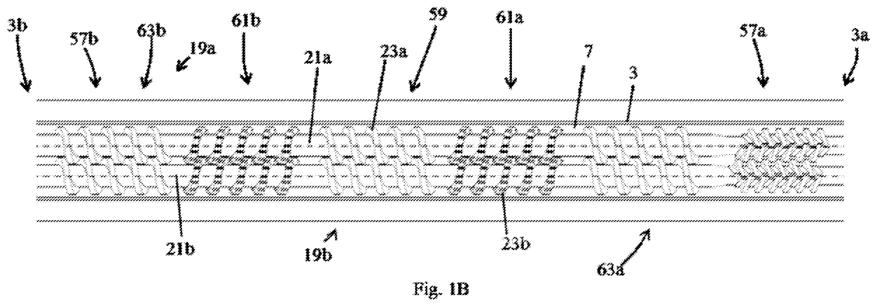

FIG. 1A illustrates a flow reactor in cut-through side view, according to a first embodiment;

FIG. 1B illustrates the arrangement of the twin screws in the flow reactor of FIG. 1A;

FIG. 2 illustrates a flow chart for carrying out a reaction it the flow reactor; of FIG. 1A;

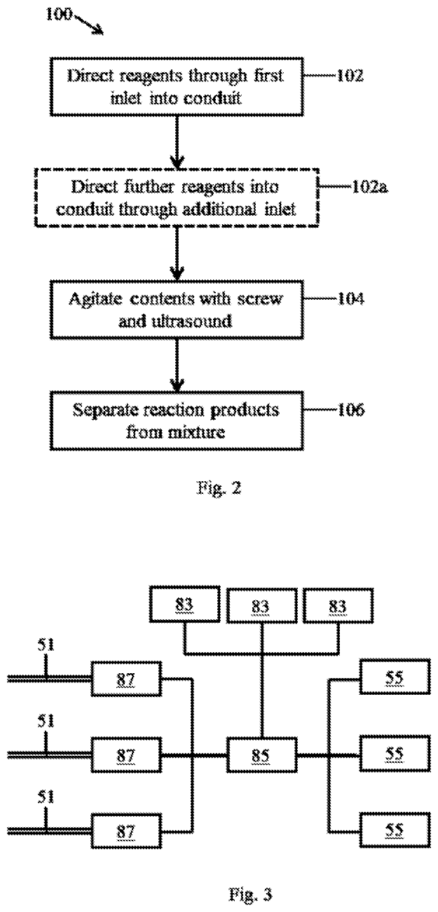

FIG. 3 illustrates an example control system for maintaining the desired temperature in the flow reactor;

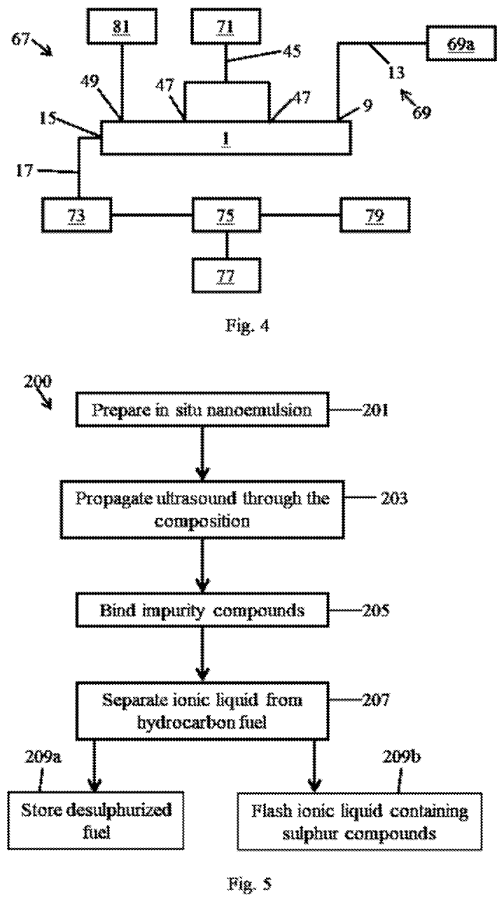

FIG. 4 illustrates a system for desulphurisation including the flow reactor; and

FIG. 5 illustrates a flow chart for carrying out a desulphurisation reaction in the flow reactor of FIG. 1A.

FIG. 1A illustrates a sectional view of a flow reactor 1 in which a chemical reaction is carried out. The reactor 1 will be described in relation to desulphurisation of fuel oil, but it will be appreciated it may also be used in other applications.

The flow reactor 1 comprises an elongate body 3 extending along an axial direction X from a first end 3a to a second end 3b. The body 3 comprises a sidewall 5 that is elliptical in cross-section perpendicular to the axis X. The sidewall 5 therefore defines an axially extending conduit 7.

Near the first end 3a of the body 3 an inlet 9 is formed in the sidewall 5. The inlet 9 comprises an opening that extends radially from the axis X and opens into the conduit 7. In use, liquid reagents 13 are provided into the conduit 7 through the inlet 9. In one example, reagents 13 are provided into the conduit by action of a pump 11 but this is by way of example only. Instead the reagents may be injected, gravity fed or fed by any other means.

As will be described in more detail below, as the liquid reagents 13 transit along the conduit 7, a reaction occurs and products 17 of the reaction are provided through an outlet 15 formed in the second end 3b of the body 3. The direction from the inlet 9 to the outlet 15 defines a flow direction with the inlet 9 being at the upstream end and the outlet 15 being at the downstream end.

A pair of rotating screws 19a, 19b are provided in the conduit. Each screw 19a, 19b extends along the direction of the conduit 7, and along substantially the whole length of the conduit 7. The screws 19a, 19b advance the reagents along the conduit 7 and mixing them. The flow reactor 1 may thus be considered to function as a screw extruder adapted for use with liquid reagents, or an Archimedes screw. FIG. 1B illustrates the arrangement of the two screws 19a, 19b in more detail.

Each rotating screw 19a, 19b comprises a central mounting shaft 21a, 21b with a helical ridge 23a, 23b formed on the outside of the shaft 21a, 21b. The mounting shaft 21a, 21b forms a rotational axis of the screw 19a, 19b. The rotational axis of the screws 19a, 19b extends parallel to each other and the axial direction X of the conduit 7.

As shown in FIG. 1B, the screws 19a, 19b extend adjacent to each other in the axial direction X. The screws 19a, 19b are offset along the axial direction X and are located close to each other, such that the helical threads 23a, 23b are intermeshing. Therefore, the radially outer part of the helical ridge 23a of the first screw 19a is received in the radially extending space formed between the central shaft 21b of the second screw 19b and the radially outer edge of the helical ridge 23b of the second screw 19b. In other words, a straight line extending parallel to the axial direction X and in the region where the two screws 19a, 19b overlap will pass through both helical ridges 23a, 23b.

A spacing may be defined as the spacing between the helical ridges 23a, 23b of the screw 19a, 19b along the axial direction X. The spacing may be less than 2 mm. Likewise, the clearance between the helical ridge 23a, 23b of one of the screws 19a, 19b and the central shaft 21a, 21b, in the direction perpendicular to the axial direction X, should also be less than 2 mm. For example, the spacing and clearance may be less than 10 microns. on one example, the spacing may be 1 micron or less.

A clearance is also formed between the sidewall 5 and the screws 19a, 19b such that the screws 19a, 19b do not contact or scrape the sidewall 5, and does not cause unwanted friction or turbulence effects, whilst still providing sufficient turbulence to mix reagents. The width of the shaft 21a, 21b is also selected to provide sufficient volume for reagents whilst also promoting mixing.

In the example shown in FIG. 1, the central mounting shafts 21a 21b (and hence rotational axes of the screws 19) are parallel to the axial direction X, with the screws 19a, 19b extending adjacent to each other. It may be that the central mounting shafts 21a, 21b extend along the foci of the elliptical cross section, or they may be offset from the foci. In yet some examples, one or both of the mounting shafts 21a, 2b may extending at an angle to the axial direction X.

The central rotating shafts 21a, 2b of the screws 19a, 19b extend out of the first end 3a of the body 3. The end of each shaft engages a drive belt 25, which in turn is driven by a motor 27.

Any suitable coupling mechanism may be used between the drive belt 25 and the central rotating shafts 21a, 21b, and/or between the central rotating shafts 21a, 21b with each other or any drive shaft. The couplings may be geared on ungeared.

To ensure the first end 3a of the body 3 remains closed, to prevent escape of the liquid reagents 13, a seal 29 is formed between the central rotating shaft(s) 21a, 21b or drive shaft and the body 3. Any suitable type seal may be used, such as a rotary shaft seal or an O-ring seal. The material of the seal should be chosen to be inert with respect to the reagents and products contained within the reactor 1 during use.

At the first end 3a of the body 3, the sidewall 5 flares outwards from the axial direction X to form a flared portion 31. The flared portion accommodates the couplings that drive the shafts 21a, 21b and the seal 29.

The second end 3b of the conduit is closed by an end cap 33. The end cap 33 may be secured by interengaging screw threads, welding or any other suitable means that sealing closes the conduit 7. The end cap 33 forms a nozzle 35 comprising a plate 35a having one or more openings 37 forming the outlet 15. The plate 35a of the end cap 33 also optionally locates the end of the central rotating shafts 21a, 21b whilst allowing the screws 19a, 19b to rotate.

Downstream of the inlet 9, a radially extending opening 39 extends through the sidewall 5 of the body 3. An ultrasonic emitter/transducer 41 extends through the opening 39 into the conduit 7. A seal is formed around the emitter/transducer 41 to prevent escape of reagents from the conduit 7. Any suitable seal, inter with respect to the reagents, may be used.

The ultrasonic emitter 41 is coupled to an ultrasonic generator 43. Any suitable ultrasonic generator 43 and emitter may be used, such as a multi-horn system. The ultrasonic wavelengths may have any frequency above 20 kHz. By way of example only, the ultrasonic generator and emitter may be a Hielscher ultrasonic homogeniser.

In use, liquid reagents 13 are provided into the conduit 7, whilst the screws 19a, 19b are rotated and ultrasonic waves emitted.

Without being bound by theory, it is suggested that the agitation caused by the rotating screw and ultrasound increased friction and shear forces, which cause cavitation in the liquid content within the flow reactor 1. The cavitation creates microbubbles that grow and collapse upon reaching a critical size. This forms shockwaves forming high temperature and pressure. This, in turn, provides energy for activating a reaction, or increasing the rate of already occurring reactions. The formation of microbubbles is particularly prevalent at the region where the screw threads 23a, 23b overlap, but is not limited to this region.

A constant flow of liquid reagents 13 is provided into the conduit at the inlet 9. The reaction occurs as the reagents 13 transit through the conduit 7 to the outlet 15 as a result of the screw 19 turning. Therefore, the contents of the conduit are continually being replaced and the reaction may be considered to be occurring continually, rather than in a batch process.

FIG. 2 illustrates a flow chart showing the process 100 of a reaction occurring in the flow reactor 1. At a first step 102, reagents 13 are introduced into the conduit 7 through a first inlet 9. The reagents are then agitated 104 by ultrasound and the screws 19a, 19b, and advanced along the conduit to the outlet 15. As will be discussed in more detail below, reaction products 17 are then taken from the outlet 15 and separated 106.

In the example discussed above, the liquid reagents 13 comprise a mixture that is able to react once the process is activated by the cavitation (or a mixture that is slowly reacting, which is sped up by the cavitation). The mixture may be pre-mixed at any point before introduction to the flow reactor 1.

In other embodiments, it may be that the liquid reagents 13 provided at the inlet 9 is mixed with other liquid reagents 45 in the conduit 7. In the example shown in FIG. 1 a pair a further inlets 47 are provided extending radially through the sidewall 5 of the body into the conduit 7. These allow for the further liquid reagents 45 to be introduced for example by pumping or injection or other means as discussed above in relation to the main inlet 9. The method 100 shown in FIG. 2 may thus further include the optional step 102a of introducing further reagents.

The further inlets 47 are provided in the downstream direction of the ultrasonic emitter 41, and are spaced along the axial direction X.

In examples where further reagents are provided through the further inlets 47, the flow reactor 1 acts to form a homogenised mixture of the liquid reagents 13 and the further liquid reagents 45, and cause activation of the reaction between the reagents 13, 45 in the same way as discussed above. It may be that the mixing and frictional and shear forces form a temporary (in situ) emulsion in the flow reactor 1 to activate the reaction.

Gasses are a possible by-product of the reaction occurring in the conduit 7. In some examples of the continuous flow reactor 1, degassing outlets 49 may be provided to allow gasses to escape and prevent build-up of pressure.

FIG. 1 shows an example of a degassing outlet 49 provided as an opening extending radially through the sidewall 3 of the body. In the example shown the degassing outlet 49 is provided downstream of the inlets 9, 47 at or near the second end 3b of the body 3 and the outlet 15. Thus, the gasses produced during the reaction, as the reagents transit along the conduit 7 are vented near the end of the conduit 7. The gas may be simply vented, stored, or provided for further processing.

It will be understood that in order for the reaction to efficiently take place, the reagents 13, 45 should be maintained within a desired temperature range. The desired range will be different for different reactions.

As discussed above, the cavitation process generates heat, and further heat may be generated by the chemical reaction. In order to remove excess heat from the flow reactor 1, ambient air may be injected into the reactor.

In order to inject ambient air, a plurality of air channels 51 are provided opening into the flow reactor conduit 7. The air channels 51 extend radially away from the axial direction X, and are spaced along the axial direction X between the inlet 9 and outlet 15. At the radially inner end of the air channels 51, a membrane 53 is provided to prevent reagents entering into the channels 51.

In one example, the membrane 53 may be a material that is permeable to air, but impermeable to the liquid reagents. In other examples, the membrane may comprise a one way valve or other structure and/or may operate under a pressure displacement to prevent reagents entering the air channels 51.

Heat may also be removed in a number of other ways, such as a cooling jacket arranged around part or all of the conduit 7, or other heat transfer or cooling technologies known in the art. It may also be appreciated that other inert gasses, such as nitrogen, may be used instead of ambient air.

It may also be necessary to provide heat to the reagents to maintain the proper reaction temperature. In order to provide heat, heaters 55 are arranged on the outside the conduit 7, arranged along the axial direction X. Any suitable type of heater, such as trace heaters, may be used.

In some situations, in order to maintain the desired temperature range, it may be necessary to use both heating and cooling at different times, in order to maintain the desired temperature.

FIG. 3 illustrates an example system for controlling the temperature in the flow reactor 1.

One or more temperature detectors 83 may be provided to measure the temperature of the reagents. The temperature detector may be provided within the conduit 7 or arranged on the outside of the conduit 7, calibrated such that the temperature of the reagents 13, 45 can be inferred from the external temperature.

The measured temperature is provided to a PID (proportional-integral-derivative) controller 85, which in turn controls the heaters 55 and compressors 87 or other sources for providing compressed air for cooling.

The helical ridge 23a, 23b of the rotating screws 19a, 19b advances the contents of the conduit 7 forward from the inlet 9 to the outlet 15. The rotating screws 19a, 19b may be rotated either clockwise or anti-clockwise. The screws 19a, 19b may be co-rotating or counter-rotating.

In one example, the screws 19a, 19b may comprise a single continuous ridge 23a, 23b extending in the same direction with constant pitch, angle and direction along the length of the central mounting shaft 21a, 21b (the pitch of the ridge 23a, 23b is the axial length to complete a single rotation around the shaft 21a, 21b, the angle of the ridge 231, 23b is the angle formed by the ridge to an axis perpendicular to the direction of the central shaft, the direction is clockwise or anti-clockwise).

In other examples, the pitch and/or angle and/or direction of the ridge 23a, 23b may vary along the length of the conduit 7. For example, in FIGS. 1A and 1B, the rotating screws 19a, 19b have regions 57a, 57b, where the pitch is a first distance and regions 59, 61a, 61b, 63a, 63b where the pitch is second distance, shorter than the first distance. Furthermore, the rotating screw 19 has regions 57a, 57b, 59, 63a, 63b where the ridge extends clockwise and regions 61a, 61b where the ridge 23 extends anti-clockwise.

The regions 57a, 57b of longer pitch and regions where the direction of the ridge 23 is reversed increase residence times of reagents 9, 45 in the flow reactor 1. The regions 59, 61a, 61b, 63a, 63b of shorter pitch cause higher levels of turbulence, increasing reaction rate in these areas.

As shown in FIG. 1A, in the region of the first inlet 9 and the outlet 15, the pitch of the ridge 23 is increased to increase residence times but reduce turbulence.

In the region of the further inlets 47, the direction of the ridge 23a, 23b is reversed but maintained at the shorter distance. This therefore ensures a region with increased residence times and turbulence to aid mixing of the reagents 13, 45.

Between the regions of reversed direction and longer pitch, the ridge 23a, 23b may proceed in the forward direction, with shorter pitch. This ensures high turbulence to mix the reagents, but also continues to advance the reagents along the conduit 7.

It will be appreciated with the pitch and direction of the helical ridge 23 may be varied in any way to change residence times and turbulence. Any property of the screw 19, such as the ridge angle, ridge direction, ridge width, pitch flight depth or clearance of the ridge, or the diameter of the shaft may be varied and the ridge may be discontinuous such that it is omitted in some regions. The pattern of the ridge 23 along the shaft may be varied in any way.

At the first end 3a of the body 3, the screws 19a, 19b includes a region without the ridges 23a, 2b, where the screw 19a, 19b engages the drive belt 25. In the direction from the first end 3a to the second and 3b, the ridges 23a, 23b starts before the inlet 9. However, it will be appreciated that this is by way of example, and the ridges 23a, 23b may be omitted in the region of the first inlet 9, and only start downstream of the inlet 9.

In the example shown in FIG. 1B, the pattern of the two helical ridges 23a, 23b are the same, but offset from each other. However, this is by way of example only, and the patterns of the two intermeshing ridges 23a, 23b may be different. For example, the directions and/or spacings of the screw threads may be different 22a, 23b. In some examples, there may be regions in which the twin screw threads 23a, 23b are co-rotating and other regions in which the twin screw threads 23a, 23b are counter-rotating.

The sidewall 5 of the flow reactor may be formed of any material that is chemically inert with respect to the reagents 13, 45, and products 17, and which, where heating is provided, allows for conductance of the heat through the wall 5. For example, the sidewall may be formed by titanium, steel or stainless steel.

Likewise, the screws 19a, 19b may also be formed from a material that is chemically inert with respect to the reagents 13, 45, and products 17 and so may be titanium, steel or stainless steel. Alloys and polymers may also be used for the screws 19a, 19b.

The example shown in FIG. 1 shows that the screws 19a, 19b and ridges 23a, 23b stop upstream of the outlet 15. However, the outlet 15 may be provided in the sidewall 5 of the body 3, and the screws 19a, 19b and ridges 23a, 23b may extend downstream from the outlet. Alternatively, the outlet 15 may be provided in the sidewall 5 and the screw 19 and/or ridge 23 may still stop upstream of the outlet 15. The outlet 15 may be formed by a single opening rather than a plurality of openings 37.

The inlets 9, 47 may be provided at any suitable position along the length of the conduit 7. For example, the first inlet 9, may be provided in the end of the body 3, rather than through the sidewall 5. Furthermore, the inlets 9, 47 may be provided at any suitable position around the circumference of the body 3. For example, the inlets 9,47 may be positioned in the region where the two screws 19a, 19b overlap, or may be positioned to one side, in the region of the only one of the screws 19a, 19b. Multiple inlets 9, 47 may be provided at different positions around the circumference at the same or different axial positions.

In use, each individual inlet 9, 47 may be used for a different reagent, or the same reagent may be provided through any two or more of the inlets 9,47. Furthermore, there may be any number of inlets 9, 47. In some applications, only a single inlet 9 at or near the first end 3a of the conduit 7 may be provided.

In the example shown, ultrasonic waves are introduced at a single point in the axial direction between the first inlet 9 and the further inlets 47. However, ultrasonic waves may be introduced at any suitable position along the length of the conduit 7. For example, ultrasound waves may be introduced after at least one of the further inlets. Ultrasonic waves may be introduced in more than one point along the length of the conduit 7, and more than one point around the circumference of the conduit 7.

Similarly, any number of degassing outlets 49 may be provided, and the degassing outlet(s) 49 may be provided at any suitable position along the length and around the circumference of the conduit 7. Alternatively, for applications where gas is not produced, the degassing outlet 49 may be omitted.

It will be appreciated that the further inlets 47 and degassing outlet 49 are, in some cases, provided by radially extending openings. Therefore, depending on the wider system 67 to which the flow reactor 1 is connected, the same opening may be used as an inlet for reagents in one application, and an outlet for degassing in another application. It may be that where the openings are not required, closing caps (not shown) can be provided.

Rotation of the screws 19a, 19b may be driven at either end of the body 3. In the example shown, rotation of the screws 19a, 19b is driven by a motor 27 coupled to the screw 19a, 19b by a drive belt 25. However, the screw 19 may be mounted on the output shaft of the motor 27, either directly or via a gearbox or other linkage.

A single drive belt 25 may be used to drive both screws 19a, 19b, or separate drive belts 25 may be used. In other examples, only one of the central rotating shafts 21a, 21b may extend out of the first end 3a of the body 3, and a linkage or connection may be provided within the conduit 7 to drive the second shaft 21a, 21b. In yet further examples, a separate drive shaft (not shown) may extend out of the first end 3a, and may be coupled to the central rotating shafts 21a, 21b of both screws.

In the example discussed above, the conduit 7 is of constant diameter along its length. It will be appreciated that this is by way of example only. In some embodiments, the diameter of the conduit 7 may be varied. For example narrowing of the diameter may help to create regions of higher pressure/turbulence where cavitation is increased and wider regions may reduce turbulence and pressure, reducing cavitation.

The example discussed above relates to a twin screw arrangement. However, it will be appreciated that this is by way of example only. In some examples, the flow reactor 1 may have a single screw 19, or may have three or more screws with intermeshing threads.

In use, the flow reactor 1 is arranged such the axial direction X is horizontal, and parallel to the ground. A support frame 65 is provided to hold the flow reactor 1 in place. In this arrangement, the two screws 19a, 19b may be at the same vertical height, or any other orientation.

In the example shown, the inlets 9, 45, degassing outlet 49 and heaters 55 are arranged on the top of the conduit 7, and the air cooling channels 51 on the bottom. The arrangement of the air channels 51 and heaters 55 provides efficient heating and cooling, in particular (but not only) for embodiments where fuel oil mixtures are used in the flow reactor. It will be appreciated that in some embodiments, the inlets 9, 45, degassing outlet 49, heaters 55 and the cooling channels 51 may be provided in any suitable position. In other embodiments, the heating and/or cooling may not be necessary.

FIG. 4 illustrates a system 67 for carrying out a reaction in the flow reactor 1 shown in FIG. 1.

First reagents are provided to the inlet 9 from a feed supply system 69 including one or more storage tank 69a. Further reagents are provided at the further inlets 47 from a second tank 71. The composition from the flow reactor 1 is taken from the outlet 15 and provided to a product storage tank 79.

In the example shown, further modules or components 73, 75 are provided between the outlet 15 of the flow reactor 1 and the product storage tank 79. These may be for further processing of the outputs. This may include, for example, catalytic reactions, separation of products and the like.

As discussed above, the gaseous by-products may also be taken from the degassing outlet 49 and stored or further processed in gas handling system 81. This may simply store the gas, or process before storage or use. Likewise, further side products may also be fed to further storage tanks 77.

It may be that the system includes valves (not shown) to control the flow of reagents. Whilst the process is continuous, it may be necessary to stop the flow of reagents to change out supplies of reagents, to flush the system or for maintenance.

It will be appreciated that the system 67 discussed above is given by way of example. The reaction may be carried out in any suitable system, and may be carried out as a batch process or a continuous process. The flow reactor 1 may be provided at any point in a chemical processing plant.

The feed supply system 69 may include further components for treating or mixing the reagents. Similarly, the reagents at the further inlets 47 may be pre-treated or pre-processed in any way. As discussed above, in some examples, the further inlets 47 may not be used.

At the outlet 15 of the flow reactor 1, any possible downstream processing may be provided, or the products may simply be stored. Alternatively, the gaseous material may be the desired product from the reaction, and the liquid components of the mixture may be the by-products.

In one example the system 67 and flow reactor 1 may be used for the desulphurization of fuel oil (either heavy fuel oil or intermediate fuel oil).

In a first example of a desulphurisation reaction, the fuel oil may be provided at the inlet 9 and an ionic liquid solvent (ILS) combined with water as a pre-mix may be provided at the further inlets 45. The flow reactor 1 then acts to form an in-situ temporary emulsion in which a desulphurisation reaction occurs.

In particular, the ILS provides a source of a reactive species including positive ions such as hydrogen ions, which bind to the sulphur impurities in the fuel oil, breaking the bonds between the sulphur atoms and the fuel oil.

In this example, the products from the outlet 15 of the flow reactor 1 is provided to a catalytic reactor 73 to bind least a portion of the sulphur compounds produced in the flow reactor 1 to the ionic liquid. Alternatively, a polar solvent may be added to bind the sulphur compounds.

After catalytic reaction or addition of polar solvent, the composition is provided to a separator 75. Any suitable separating means 75 may be used, such as a gravity tank, a centrifuge, or a distillation column.

From the separating means, the desulphurized fuel oil is provided to a storage or service tank 79, whilst the ionic liquid composition containing the sulphur compounds is then transferred to a flashing unit 77. The flashing unit 77 separates the ionic liquids from the heavy metals and sulphur, which is left as a sludge residue within the flashing unit 77. The sludge residue is transferred to holding tanks or to separate drying and bagging unit (not shown) for further handling.

In a second example of a desulphurisation reaction, the fuel oil may again be provided at the inlet 9. In this case, only water is provided at the further inlets 47. Again, the flow reactor 1 then acts to form an in-situ temporary emulsion in which a desulphurisation reaction occurs.

In this case, the water is chemically broken down, forming a reactive species such as hydrogen ions. As in the first example, the positive ions bind to the sulphur impurities in the fuel oil, breaking the bonds between the sulphur atoms and the fuel oil.

The product is taken from the outlet 15 and the sulphur containing compounds can be obtained in any suitable way. For example, a polar solvent may be added in a mixing tank 73 to bind to the sulphur compounds. A separator 75 may then be used in a similar fashion to the first embodiment.

FIG. 5 shows a flow chart generally illustrating a desulphurisation process 200. At a first step 201, an in situ nanoemulsion (or emulsion) comprising a hydrocarbon fuel and a positive ion source is prepared.

The positive ion source may either be water (which is broken down in the flow reactor), or a premix of water and an ILS. In the second case, the nanoemulsion may be prepared by combining the hydrocarbon with a pre-mix, the pre-mix comprising the ionic liquid and the water.

At a second step 203, the ultrasonic waves are propagated through the composition. At a next step, the sulphur compounds are bound. This may be by, for example, catalytic reaction or mixing with a polar solvent.

In one example, the ultrasonic waves are propagated through the composition prior to any further processing, such as catalytic reaction or mixing with the polar solvent. This may be in the flow reactor 1 as discussed in the example above. Alternatively, this may be in a static mixing tank for a fully batch process. This may be in the same tank as the catalytic reaction or mixing with the polar solvent

At a next step 207, the sulphur compounds are separated from the fuel oil. After separation 205, the desulphurized fuel oil is then stored 207a, and the ionic liquid containing the sulphur compounds is flashed 207b.

The above method is given by way of example only. It will be appreciated that any suitable method may be used in which a fuel oil is mixed with a source of a reactive species to create a nanoemulsion, and acoustic cavitation from ultrasound is used to activate the desulphurisation reaction.

The method and system described above may also be used to remove other impurities, such as nitrogen or oxygen in bio-diesel. Furthermore, any other suitable reaction may be activated in the flow reactor 1.

A specific example of desulphurisation of fuel oil using an ILS will now be described.

### Example: ILS-HMD Refinery System

The ILS-HMD refinery system employs ionic liquid solvents (ILS) in a hybrid modular desulphurization system (HMD), which employs the flow reactor 1.

### Module Properties

### Module Flow Reactor Size: 4,000 Litres

Module Flow Reactor Capacity (Per Hour): 3,600 Litres (3,600 Litres of Liquid fuel with a up to 3.5% sulphur can be converted to 0.5% sulphur or lower as needed.)

### Module Flow Reactor Electricity Usage (Per Hour): 4 Kilowatts/Hour

Module Flow Reactor ILS Consumption (Per Hour): 80 litres
Module Ultrasound Frequency Range (Varies depending on Specific Liquid Fuel): 300-400 kHz

A study was carried out using_IFO 380—Intermediate fuel oil with a maximum viscosity of 380 centistokes (<3.5% sulphur). For each hour, 3,600 litres of IF0 380 was mixed in the flow reactor 1 with 320 litres of water and 80 litres of ionic liquid to generate an emulsion. The ILS and the water were combined to form a pre-mix before addition to the flow reactor.

A mixture of ionic liquids provided the best performance:

| | |
|---|---|
| 50 to 70% | [BMIM-PF₆] |
| 20 to 40% | [BMIM-BF₄] |
| 10 to 20% | [BMIM-OTf] |

The emulsion was transferred to a catalytic reactor after 20 minutes in the flow reactor. A desulphurized fuel oil (0.5% sulphur or lower) was subsequently separated from the ionic liquid.

The process is more efficient than either a traditional desulphurization employing hydrogen or the use of ILS alone. In particular, the use of ultrasound (i.e. the sonolytic aspect of the process) is believed to generate hydrogen in situ and thereby provide desulphurization together with the ILS.

Each module functions as a continuous process, with a 20-minute reaction interval. Scaling up refinery operations is quite simple since the continuous process is modular. A modular continuous refinery approach to desulphurization means that fixed costs are flexible, based on scale. A single small refinery can easily become a large refinery simply by activating additional modules. Each module is self-contained and fits in a standard shipping container.

1-30. (canceled)

31. A flow reactor comprising:
a cylindrical body defining a conduit extending from a first end to a second end;
a conduit inlet for providing a flow of a liquid reagent into the conduit, the conduit inlet at or near the first end;
a conduit outlet for providing a flow of a liquid content from the conduit, the conduit outlet at or near the second end;
one or more rotating screws arranged within the conduit and extending in the conduit, the rotating screw arranged to rotate about an axis extending from the first end to the second end, to direct the liquid content from the conduit inlet to the conduit outlet; and
one or more ultrasonic emitters arranged to emit ultrasound waves in the conduit.

32. The flow reactor as claimed in claim 31, comprising one or more further inlets for providing a flow of a further liquid reagent into the conduit, the one or more further inlets arranged along the conduit between the conduit inlet and the conduit outlet.

33. The flow reactor of claim 32, wherein each of the one or more screws comprises a central mounting shaft extending along the axis of rotation with a helical ridge arranged around an outside of the shaft; and wherein the helical ridge extends in a first direction in the region of the further inlets, and in an opposite direction between the further inlets.

34. The flow reactor of claim 32, wherein the screw comprises a central mounting shaft extending along the axis of rotation with a helical ridge arranged around an outside of the shaft; and wherein a direction and/or pitch of the helical ridge varies along the shaft.

35. The flow reactor of claim 34, wherein the pitch of the ridge is longer in the region of the conduit inlet than in regions downstream of the conduit inlet.

36. The flow reactor as claimed in claim 31, comprising a pair of screws having intermeshing screw threads.

37. The flow reactor as claimed in claim 31, comprising one or more cooling channels arranged to direct a cooling gas into the conduit, the cooling channels arranged along the conduit between the conduit inlet and the conduit outlet.

38. The flow reactor of claim 37, wherein the conduit extends horizontally, and wherein the cooling channels open into a lower part of the conduit.

39. The flow reactor of claim 37, wherein the cooling channel comprises a membrane to block reagents entering the channel.

40. The flow reactor of claim 31, comprising heaters arranged to heat the conduit.

41. The flow reactor of claim 40, wherein the conduit extends horizontally, and wherein the heaters are arranged to heat an upper part of the channel.

42. The flow reactor of claim 31, comprising a degassing outlet, arranged to allow escape of gaseous reactant products from the conduit.

43. The flow reactor of claim 31, wherein the one or more ultrasonic emitters is arranged at or near of the first end of the conduit.

44. The flow reactor of claim 31, wherein the conduit comprises a radially extending opening into the conduit, arranged to receive the ultrasonic emitter.

45. A system comprising:
a flow reactor comprising:
a cylindrical body defining a conduit extending from a first end to a second end;
a conduit inlet for providing a flow of a liquid reagent into the conduit, the conduit inlet at or near the first end;
a conduit outlet for providing a flow of a liquid content from the conduit, the conduit outlet at or near the second end;
one or more rotating screws arranged within the conduit and extending in the conduit, the rotating screw arranged to rotate about an axis extending from the first end to the second end, to direct the liquid content from the conduit inlet to the conduit outlet; and
one or more ultrasonic emitters arranged within the conduit,
a feed supply for providing liquid reagent to the input of the flow reactor; and
a tank for storing product from the flow reactor.

46. The system of claim 45, comprising a separator arranged to receive the flow from the conduit outlet of the flow reactor, and arranged to separate the constituent parts of the liquid provided from the conduit outlet.

47. The system of claim 45, comprising a catalytic reactor downstream of the flow reactor.

48. A process to desulphurize a hydrocarbon fuel that comprises sulphur compounds, the process comprising: providing a composition comprising the hydrocarbon fuel and source of a reactive species, wherein ultrasound waves are propagated through the composition to activate a reaction between the reactive species and sulphur atoms, to remove sulphur from the hydrocarbon fuel.

49. A process as claimed in claim 48, wherein the source of a reactive species comprises an ionic liquid in a water emulsion or water without an ionic liquid, in an emulsion with the hydrocarbon fuel.

50. The process of claim 49, wherein the emulsion is formed in situ within a flow reactor.
